(19) United States
(12) Patent Application Publication
(10) Pub. No.: US 2009/0016559 A1
(43) Pub. Date: Jan. 15, 2009

(54) TELECOMMUNICATION AND ELECTRONIC DEVICES HOLDING APPARATUS AND METHODS

(76) Inventor: Renee Michelle Cleary, Manhattan Beach, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/172,053

(22) Filed: Jul. 11, 2008

Related U.S. Application Data
(60) Provisional application No. 60/949,241, filed on Jul. 12, 2007.
(60) Provisional application No. 60/981,566, filed on Oct. 22, 2007.
(60) Provisional application No. 61/031,660, filed on Feb. 26, 2008.

(51) Int. Cl. H04R 1/10

(52) U.S. Cl. 381/375; 381/380; 381/378

(57) ABSTRACT

Wearable holding apparatus and methods for securing and storing wireless or wired telecommunication and electronic devices. The apparatus includes a holding unit attached on a user's body or the clothing or accessories of a user or otherwise proximate to the user and having one or more cords attached to the device during both use and non-use. The device is not only convenient to use but is secured from loss. The cord can be dispensed from a cord retracting mechanism for use and the cord retracted back into the mechanism following use. The user can transition from storage of the devices to use of the devices using only one hand and without visual contact with the device or storage unit. The apparatus is small in size and light in weight to allow the user to wear a wireless hands-free device on the ear while attached to the holding unit during use of the apparatus.

### RELATED APPLICATION DATA

This application claims the benefit of U.S. Provisional Application Ser. No. 60/949241 filed Jul. 12, 2007, U.S. Provisional Application Ser. No. 60/981566 filed Oct. 22, 2007 and U.S. Provisional Application Ser. No. 61/031,660 filed Feb. 26, 2008, the disclosures of which are incorporated herein by this reference.

### BACKGROUND OF THE INVENTION

1. Field of the Invention

Embodiments of the invention relate to the field of electronic and telecommunication devices that are small in size. More particularly, embodiments of the invention relate to a wearable holding unit to secure small electronic devices, such as wireless earpieces, during and between uses.

2. Description of the Related Art

Devices, such as wireless headsets or earpieces (generically earpieces), that allow users to wirelessly connect to a base station, network or other signal sources or allow the user to communicate directly with other parties are also widely used by many people. Such devices may be small, making it easy to lose the device or difficult to find the device. Because using such devices while driving a vehicle can be very dangerous and can lead to an accident, it is advisable, and in some areas required, to use a hands-free communication device to utilize the functionality of such telecommunication devices. As a result, such wireless devices are becoming even more common.

For example, a conventional/non-wireless hands-free communication device is comprised of a microphone and speaker which is connected to the telecommunication device, such as a mobile phone via a cable. Such devices may be hung over the user's ear or snugly placed in the ear. Such a hands free device allows the user to use the telecommunication device, such as answering and making calls with minimal interaction with the phone, thereby freeing the use of both hands during the majority of the interaction and minimizing the risks of traffic accidents caused by using one hand to hold a telecommunication device.

Although the hands-free device is smaller, is attached to the telecommunication device and doesn't require the use of hands, such a device has undesirable disadvantages. For example, the hands-free device, corresponding cable and telecommunication device may not be located proximately to the user, which requires the user to locate or find the telecommunication device before using the hands free device. Further, the cable may be tangled or wrapped around the device and need to be unwrapped or untangled prior to using the device and is inconvenient to use and store. To initiate interaction with the telecommunication device, the user will likely need to locate and press the appropriate buttons or area of a screen of the telecommunication device. While operating a vehicle, such distractions likely increase the risks of traffic accidents.

To solve the problems caused by using the cables, wireless transmission may replace the traditional wired transmission. Wireless transmission technologies such as BLUETOOTH are widely used in telecommunication devices, such as mobile phones. Such wireless devices solve some of the issues associated with the wired model. However, the reduced size, weight, lack of an attaching cord, and seeming convenience of the tiny hands-free communication devices or earpieces have caused new inconveniences and adverse affects. The reduced size has resulted in these units being difficult to locate and easy to lose. When the hands-free device is not in use, a user may leave the unit in his ear or hung over his ear, but that too creates adverse and inconvenient effects, such as numbness or pain in the ear lobe where the BLUETOOTH device is attached or loss of hearing in the ear to which the unit is located when the unit is not in use. Additionally, walking around with a plugged ear is not fashionable.

To solve the problem of securely and conveniently storing such wireless devices, some manufacturers have installed a looping hole for a lanyard type device to attach to the hands-free device. However, lanyards are generally bulky and threading or removing the lanyard to or from the loop is difficult and requires dexterity. Further not all wireless units have such lanyard loops in the frame of the device.

In one proposed solution, U.S. Patent Application Publication No. 2005/0070345 Pan discloses a carrying member that the wireless unit may be attached to when the unit is not in use. The wireless unit must be unattached from the fastening hole before use and reattached to such fastening hole after use. The wireless unit is not securely stored in the hole of the carrying member during use and may be lost or misplaced. Such a process also likely requires the use of the eyes and both hands and may increase the risk of accidents when driving, particularly if a call is initiated or terminated while operating a vehicle.

Further, electronics devices may have smaller components that wirelessly transmit data to another device. The smaller component or electronic device may need to be attached to a holding device. Currently lanyards may be used for such holding devices. However, the many devices lack a hole for hanging attachment.

### SUMMARY

An apparatus and method to ensure accessibility of a wireless earpiece is disclosed. A loop having a continually adjustable size is provided to receive a protrusion of a wireless earpiece. A lock holds the loop at a selected size to securely retain the earpiece. The lock and loop are coupled to an attachment mechanism that ensures the loop with the retained earpiece remains proximate to the user both in use and when removed from the use position.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1A is a perspective view of an embodiment of the present invention appended to a wireless device used in conjunction with a telecommunication device.

FIG. 1B is a side view of the wireless device with the holding unit loosely looped around the earpiece prior to being secured according to an embodiment of the present invention.

FIG. 1C is a side view of the wireless device with the holding unit loosely looped around the ear loop prior to being secured according to an embodiment of the present invention.

FIG. 2A is a perspective view of an embodiment of the holding unit used in conjunction with a chain or cord prior to inserting the device into the loop of the holding unit according to another embodiment of the present invention.

FIG. 2B is a perspective view of the device of FIG. 2A from a side view once the earpiece has been placed inside the loop.

FIG. 2C is a perspective view of FIG. 2A from the rear view when the sliding clasp has the tension released by pressing and securing the earpiece.

FIG. 2D is a perspective view of FIG. 2A from a front view once the earpiece has been secured in the holding unit.

FIG. 3A is a perspective view of an embodiment of the loop and lock used as a pendant that can be removable or non-removable and can be attached to a chain or cord or other material described below prior to inserting the earpiece into the loop of the holding unit according to another embodiment of the present invention.

FIG. 3B is a perspective view of FIG. 3A from a rear view once the wireless device has been placed inside the loop and the tension is released prior to securing the earpiece.

FIG. 3C is a perspective view of FIG. 3A from a front view once the earpiece has been secured in the holding unit.

FIG. 4A shows an embodiment of the loop and lock used as a pendant that can be removable or non-removable prior to inserting the device into the loop according to another embodiment of the present invention.

FIG. 4B is a rear view of FIG. 4A once the device has been placed inside the loop after the tension is released, the loose end is pulled to secure the device.

FIG. 4C is a front view of FIG. 4A once the device has been secured in the holding unit.

FIG. 5A is an embodiment of the lock and loop attached to a clasp or other attachment mechanism to attach to a user's body or clothes prior to inserting the device into the loop of the holding unit according to another embodiment of the present invention.

FIG. 5B is a rear view of FIG. 5A once the device has been placed inside the loop and the tension is released and the loose end is pulled to secure the device.

FIG. 5C is a front view of FIG. 5A once the device has been secured in the holding unit.

FIG. 6A is an embodiment of the holding unit attached to a clasp or other mechanism to attach to a user's body or clothes prior to inserting the device into the loop of the holding unit according to another embodiment of the present invention.

FIG. 6B is a rear view of FIG. 6A once the wireless device has been placed inside the loop and the tension is released and the loose end is pulled to secure the device.

FIG. 7A is an embodiment of the holding unit attached to a clasp or other mechanism to attach to a user's body or clothes prior to inserting the device into the loop of the holding unit according to another embodiment of the present invention.

FIG. 7B is a rear view of FIG. 7A once the device has been placed inside the loop.

FIG. 7C is a front view of FIG. 7A once the tension has been released and the device has been secured in the holding unit.

FIG. 7D is a view of FIG. 7C once the cord has been dispensed.

FIG. 8A is an embodiment of the holding unit attached to an earring or similar device prior to inserting the device into the loop according to another embodiment of the present invention.

FIG. 8B is a rear view of FIG. 8A once the wireless device has been placed inside the loop and secured.

FIG. 9A is another embodiment of the holding unit as comprising a spring or wire device that attaches to the earpiece prior to inserting the earpiece into the spring or wire of the holding unit.

FIG. 9B is a side view of FIG. 9A once the earpiece has been placed inside the spring or wire unit.

FIG. 9C is a view of an embodiment of the holding unit that wraps around the neck of the earpiece and is hooked by a clasp, hook and loop material, magnets or other attachment device.

FIG. 9D is a side view of FIG. 9A once the earpiece of the wireless device has been placed inside the loop of the wrapping unit and the ends are attached.

FIG. 10A is an embodiment of a holding unit with multiple attachment devices that allow connection to earpieces or electronic devices.

FIG. 10B shows an embodiment described in FIG. 10A when two devices are simultaneously placed in the ears of a user.

FIG. 10C shows another embodiment of a retractable pull reel that is attached to two separate wireless devices.

FIG. 10D shows that the cords in FIG. 10C may be pulled to extend the cord, which will hold the position as shown.

FIG. 11A shows another attachment mechanism. This embodiment includes an unlooping cord to assist in removing the device from the holding unit.

FIG. 11B shows how the cord is threaded between the ends of the necklace and where the unlooping cord is located and pulled through to create a looping holding mechanism.

FIG. 11C shows the looping holding mechanism in a tighter position around the earpiece of the wireless device.

FIG. 11D shows another view of FIG. 11C.

FIG. 11E shows another view of the embodiment of FIG. 11C.

FIG. 11F shows how the unlooping cord may be pulled to release the wireless device.

FIG. 12A is a view of another embodiment of the invention having a slider lock.

FIG. 12B shows another view with the slider moved to a more proximate location to the earpiece of the wireless device.

FIG. 13A is a front view of another embodiment of a holding unit of the present invention similar to the embodiment shown in FIG. 4A.

FIG. 13B shows a further embodiment of a holding unit of the present invention similar to the embodiment shown in FIG. 4A.

FIG. 14A shows an embodiment of the present invention with the looping holding mechanism having an unlooping cord and a lock.

FIG. 14B shows an embodiment of the present invention with the looping holding mechanism with an unlooping cord attached to an electronic sound device.

FIG. 15A shows an embodiment of the present invention with the wireless telecommunication device having an internal retractable cord for attachment to the wired earpiece device.

FIG. 15B is another view of the embodiment shown in FIG. 15A.

FIG. 16A shows an embodiment with two retractable cords within the telecommunication device.

FIG. 16B illustrates one embodiment of the telecommunication device in FIG. 16A.

FIG. 17A shows an embodiment with a clip attachment mechanism.

FIG. 17B illustrates the side view of FIG. 17A that shows the location of the two reels.

FIG. 17C is a condensed view of FIG. 17A with one cord dispensed.

FIG. 17D shows FIG. 17C with the dispensed cord with the microphone in a retracted position.

FIG. 17E shows FIG. 17D with the expanded microphone that may be angled toward the mouth of the user so that the user doesn't need to hold the cord up to the mouth.

FIG. 18A shows an embodiment of the internal working of the “pull to stop” functionality with a tear dropped shaped stopper.

FIG. 18B illustrates one embodiment of the mechanism in FIG. 18A and shows the position of the stopper once the dispensation has ceased. This holds the cord at its extended position.

FIG. 18C illustrates one embodiment of the mechanism in FIG. 18A and shows the change of direction in the stopper when the cord/wire is dispensed with a quick tug.

FIG. 18D illustrates one embodiment of the mechanism in FIG. 18A and shows the post tug recoil position of the stopper and continuous recoil motion of the reel.

### DETAILED DESCRIPTION

Embodiments of the invention allows users to more securely attach and detach the lanyard like attachment without the need for a lanyard loop hole in the plastic.

Some embodiments of the present invention also incorporate additional embodiments of the retractable cord into the headset so that the electronics receiving device is capable of being attached or secured to the body or clothing or accessory of the user so that there are no dangling wires; however, the sound transmission device may easily be moved from the hands free unit to the ear.

Also to minimize or eliminate the issue of users of sound transmission receiving devices, e.g., a microphone on the wire of a headset, the present invention incorporates an extendible microphone from the sound transmission device that may easily be retracted toward the mouth so that the user doesn't need to hold the microphone to the mouth during use.

In one embodiment, the proposed invention also incorporates a mechanism for controlling the retractable reel with “pull to stop” functionality. This functionality is not easily achieved in a consistently performing device when subjected to dropping or extreme movement. Whereas many of the new pull reels with this functionality utilize a ball bearing with a round or oval track that may easily become displaced, and this embodiment with a tear shaped lever uniquely solves this problem.

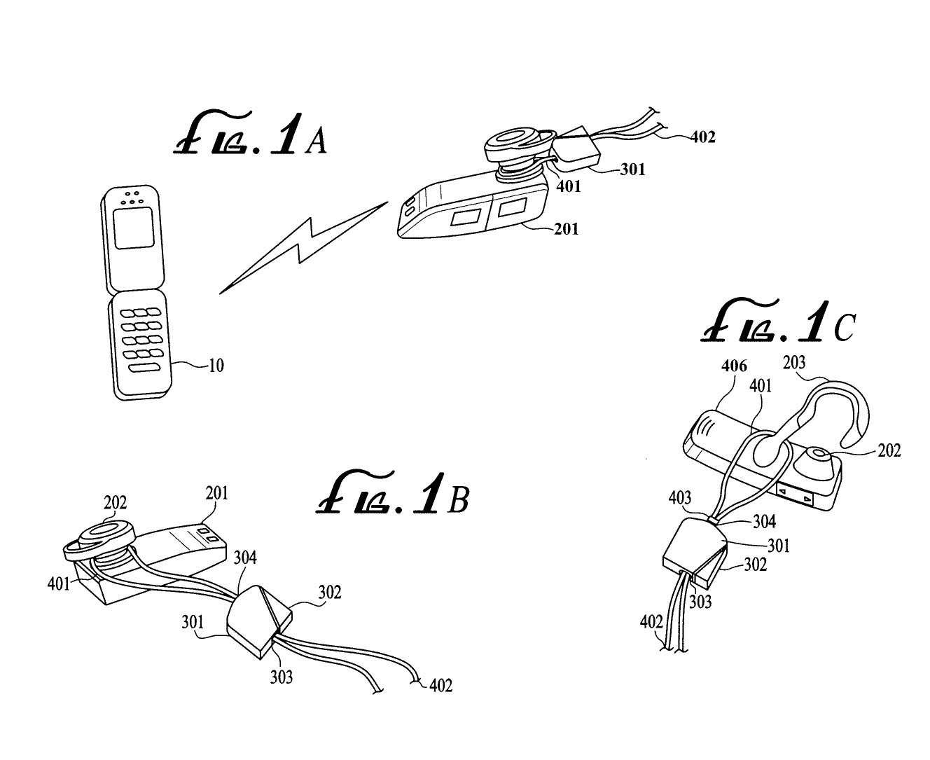

Referring to FIG. 1A, embodiments of the present invention include a base unit, such as mobile phone 10 which may transmit and receive signals, a hands-free wireless device, such as earpiece 201 and a holding unit that is comprised of a lock 301, a loop 40, and an attachment mechanism 402.

As used herein, wireless earpiece refers to any earpiece that receives wireless signals and conveys sound to a user's ear whether or not the earpiece also includes a microphone and transmitter to convey signals back to a base unit. As used herein, a lock includes any device that can maintain a selected size of a loop that is continuously variable with a range. Various embodiments of the lock are described below.

The holding unit should be small in size and light in weight so that the wireless device 20 may be placed and hung in the user's ear while the earpiece 201 is retained by the loop. Generally, a maximum cross dimension of less that an inch and a half is preferred. Some embodiments have a maximum cross dimension less than one inch. Typically, the lock will weigh less than an ounce and often less that half an ounce. The attachment mechanism 402 may be part of or attached to a cord, wire, necklace or other item hung around a user's neck or attached to a user's body such as, clothing or accessories. As used in this context, accessories include purses, bags, brief cases, glasses, and the like. In FIG. 1B, the loop 401 of the holding unit is placed around the neck 202 of the earpiece 201. In this embodiment, the loop 401 is formed from a length of cord passing through the lock 301. Lock 301 includes a tension release mechanism 302, an entry hole 303 and an exit hole 304. When tension release mechanism is depressed, frictional engagement of the cord by the lock 301 reduces to allow the lock to move freely along the cord to enlarge or reduce the size of the loop 401 along a continuum. By permitting the continuous variance of the loop size, a wide array of wireless earpieces can be accommodated. Once lock 301 has been moved to shrink the loop 401 so the loop 401 snugly engages the neck 202 of earpiece 201 and the tension release mechanism 302 is released, the lock frictionally engages the cord and holds the loop at the selected size securely retains the earpiece 201.

FIG. 1C reveals the versatility of this embodiment. In this example, the loop 401 is attached to the ear hook 203 of an earpiece 206. This embodiment may also include a spacer 403 between the exit hole 304 of the lock 301 and the loop 401 to provide a separating distance between the lock 301 and the user's ear when the earpiece 206 is in use. In one embodiment, spacer 403 may be a small length of tube having a diameter that permits it to move along the cord forming loop 401, but being too large to enter exit hole 304 of the lock 301.

A spacer, such as spacer 403 may be used in any of the embodiments shown in the attached Figures or may be integrated with the lock 301. Examples of an integrated spacer embodiment are discussed below with reference to FIGS. 13A and 13B. The earpieces 201 and 206 are only examples of the impaired earpiece configurations existing. No particular configuration is required for the embodiments of the invention to operate. As a general matter, the loop 401 will engage a protrusion, e.g. neck or ear loop of the earpiece unobtrusively so the loop may remain connected to the earpiece both while in use and when the earpiece is removed from the ear to a non-use position.

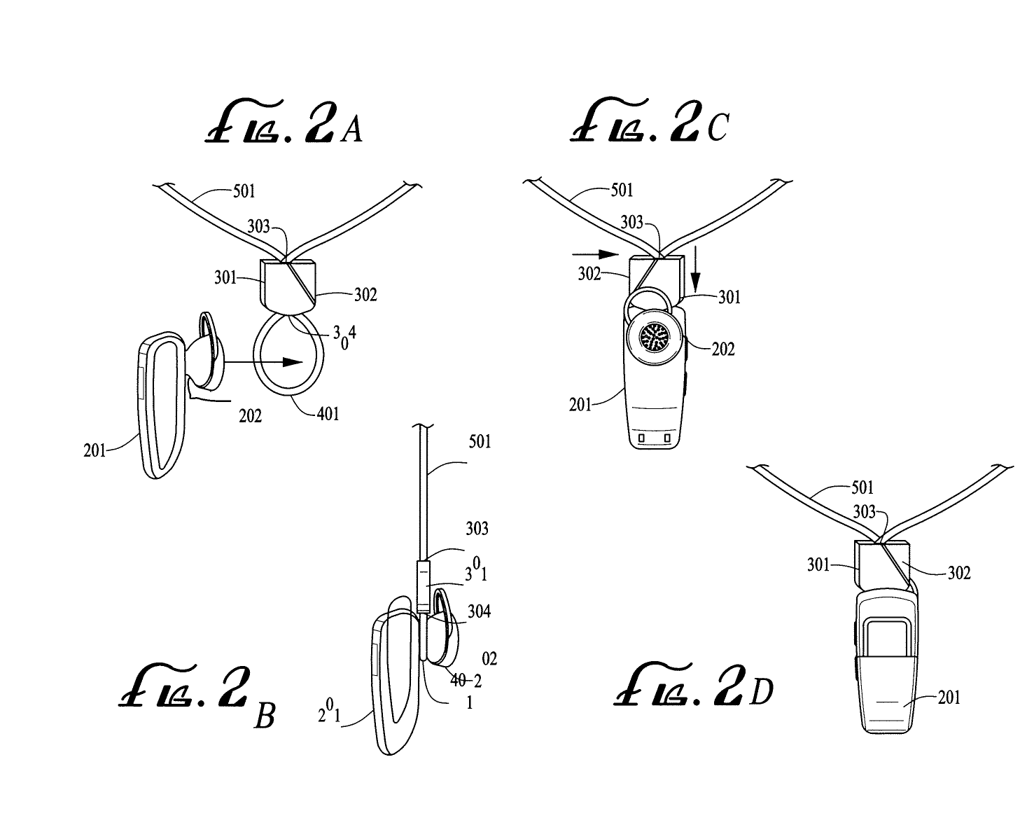

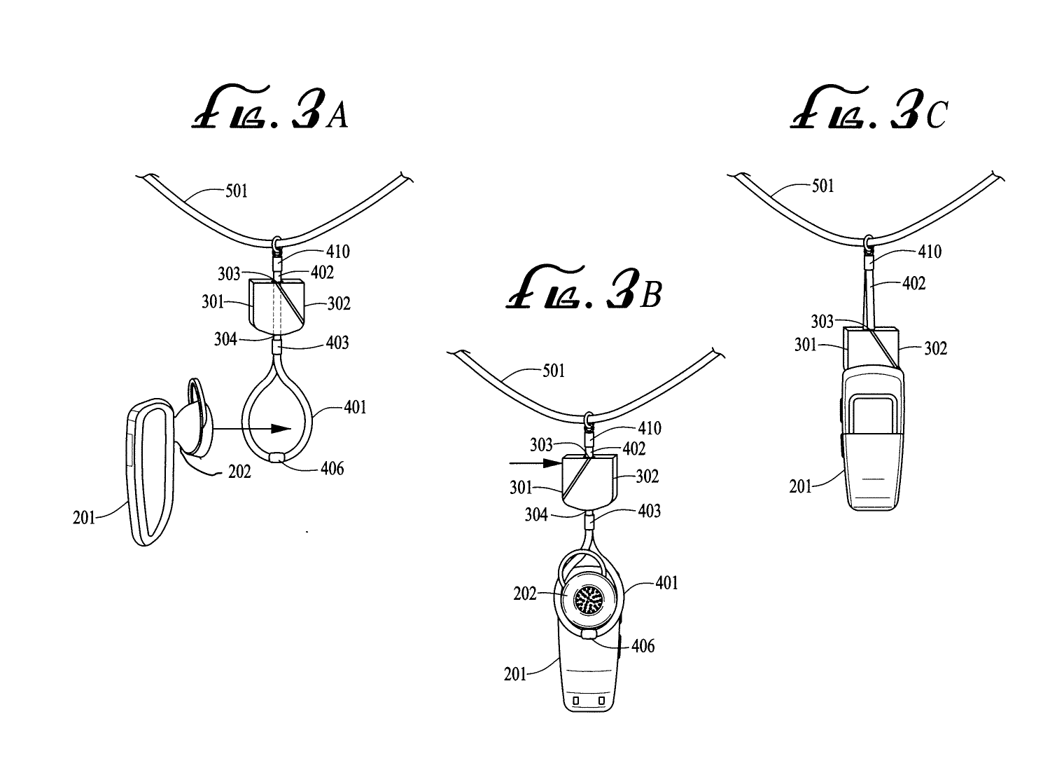

FIG. 2A shows an embodiment in which the attachment device 501 is continuous with the loop 401. The lock 301 is placed on the attachment device 501 to create the loop 401. When the size of the loop 401 increases, the size of the attachment device 501 decreases. FIG. 2B shows the side view of the earpiece 201 with the loop 401 around its neck 202. FIG. 2C shows the lock 301 moved toward the neck 202 by applying pressure at 302 thereby securing the neck 202 of the device 201 in the loop 401. FIG. 2D shows the front view of the secured earpiece 201. Such an embodiment permits a user to wear the earpiece as a necklace for quick and convenient access to the earpiece. When removed from the ear, the earpiece drops back to a known position on a user's chest.

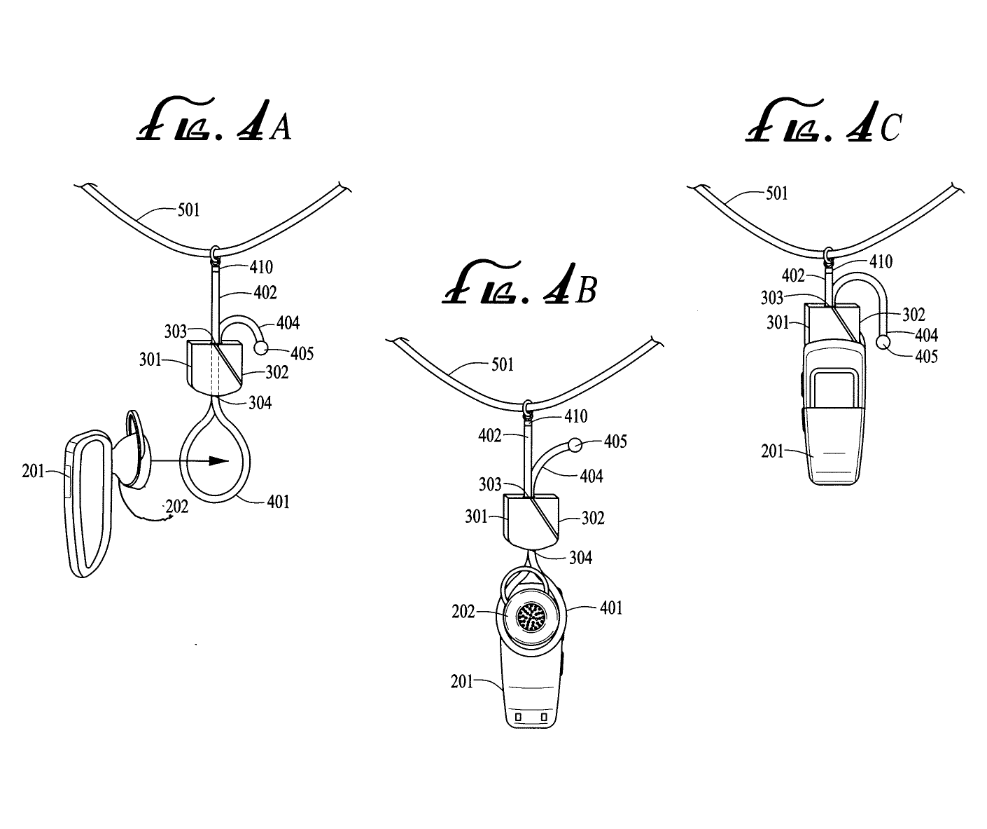

FIG. 3A is another embodiment that shows the lock and loop as a separate pendant. In this drawing, the lock 301 is coupled to the attachment device 501 by a connector 410 that may be removable, interchangeable or permanent. In one embodiment, connector 410 includes a common jewelry clasp. A spacer 403 coupled along the loop 401 at the top (above the earpiece) and a stop 406 is coupled at the bottom of the loop 401. The stopper 406 prevents the loop 401 from exiting through the spacer 403 and lock 301. In some embodiments the same functionality may be provided directly by the lock 301. The neck 202 of the earpiece 201 is placed through the loop 401. FIG. 3B shows the loop 401 being tightened by applying pressure at 302 and sliding down the lock 301. FIG. 3C shows the front view of wireless device 201 secured by the lock 301. The spacer 403 although not shown in some of the other Figures may be utilized with any of the embodiments. The spacer 403 by providing space between the lock and the loop, permits a slightly larger lock 301 without impeding earpiece insertion.

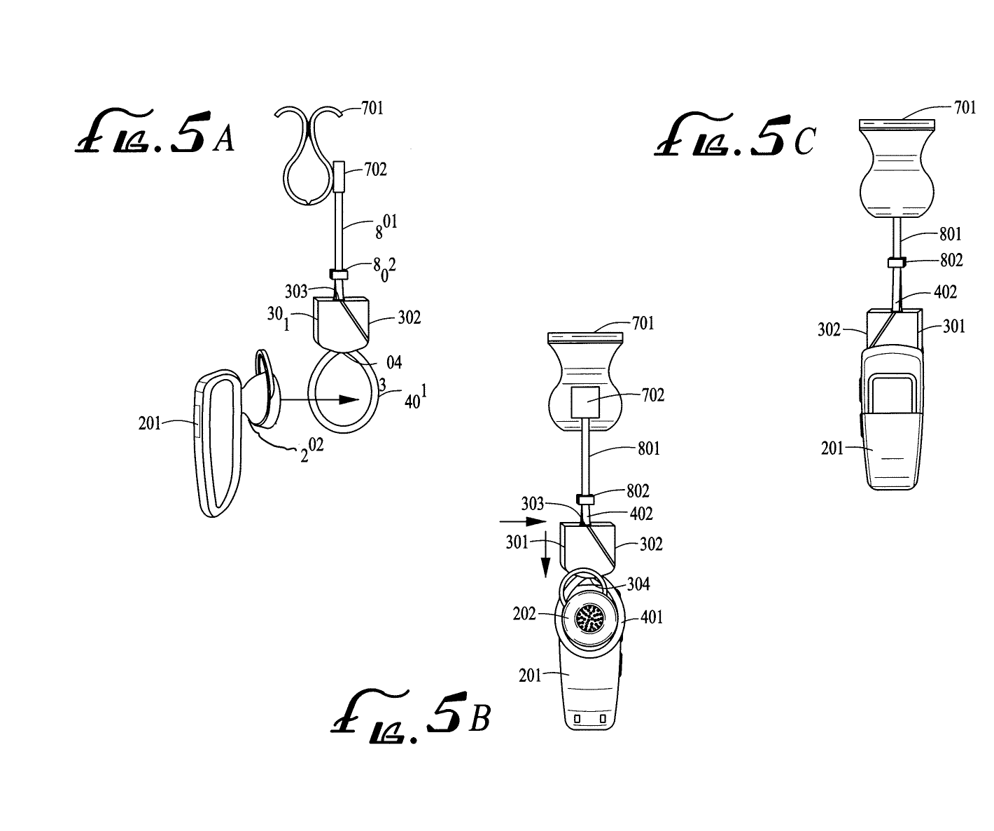

FIG. 4A is another embodiment that shows the lock and loop as a separate pendant. In this drawing, the holding unit is attached to the attachment device 501 by a connector 410 that may be removable, interchangeable or permanent. The neck 202 of the wireless device 201 is placed through the loop 401. FIG. 4B shows the loop 401 being tightened by applying pressure at tension release mechanism 302 and pulling the loose end 404 at the end 405. FIG. 4C shows the front view of the loose end 404 falling at the side of the lock 301. This style of pendant allows the user to reduce the pendant total length which may be desirable for style and functionality. FIG. 13A and FIG. 13B show embodiments illustrating additional embodiments of separate pendants that operate as the embodiments describe with reference to in FIG. 4A through FIG. 4C.

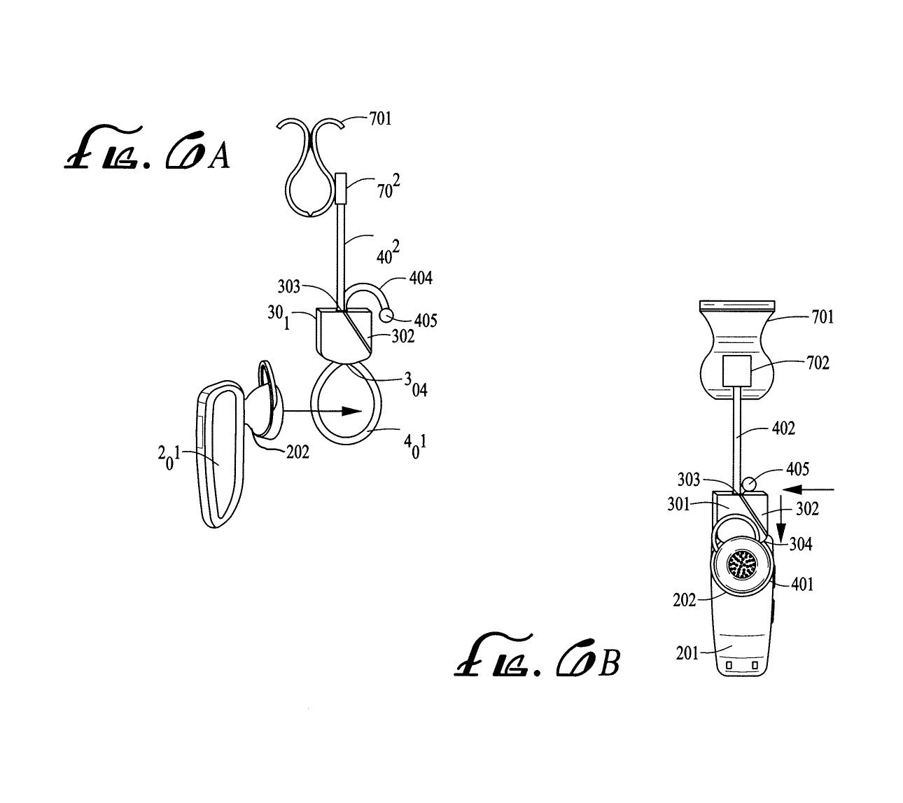

FIG. 5A is another embodiment that shows the loop 401 and lock 301 coupled to an attachment device, such as clasp 701. Such attachment device 701 may be include a clasp, pin or other device that is attached to the user's body or clothes or accessories or the surface that maintains known proximity to the user. In this embodiment, a clasp 701 is shown. From the attachment point 702 a flexible member 801 is attached. The flexible member 801 attaches to the holding unit at an attachment point 802.

The holding unit in FIG. 5 operates similarly to the holding units described above in FIG. 1 to FIG. 3. This embodiment allows the user to attach the holding unit to his clothes or accessories for convenient and quick access. For example, this embodiment may be attached to the user's collar, so that it may be conveniently reached to answer calls or to otherwise use the earpiece 201. This embodiment is ideal for those who do not want to wear an attachment mechanism around his or her neck.

FIG. 6A is another embodiment that shows a similar clasping device 701 as described in FIG. 5A. The holding units in FIGS. 6A and 6B operate similarly to the holding units described above in FIGS. 5A and 5B.

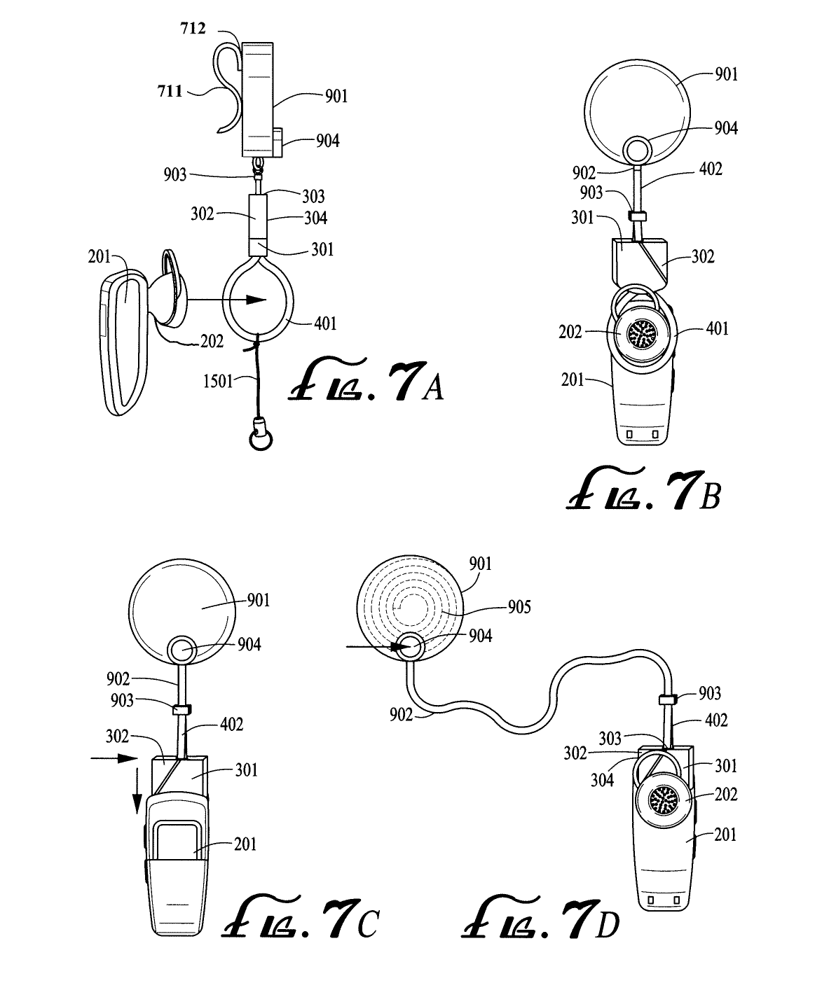

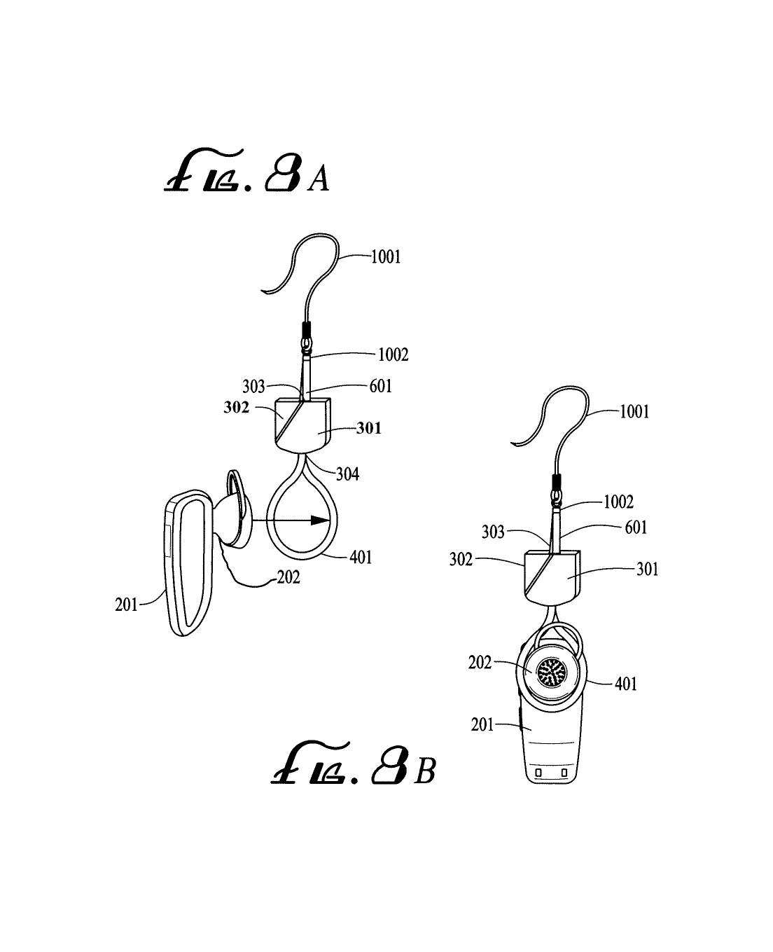

FIG. 7A shows another embodiment with attachment device 711 attached at the attachment point 712 to an automatic cord retracting mechanism 901. This embodiment includes an extendible cord 902 that may be extended or retracted by pressing a button 904 or by gently tugging (not shown) on the cord 902. In one embodiment, extension does not require activation of button 904, and activation of the button 904 initiates an automatic retraction of the extended cord 902. In another embodiment, a gentle tug on the cord causes the cord to retract.

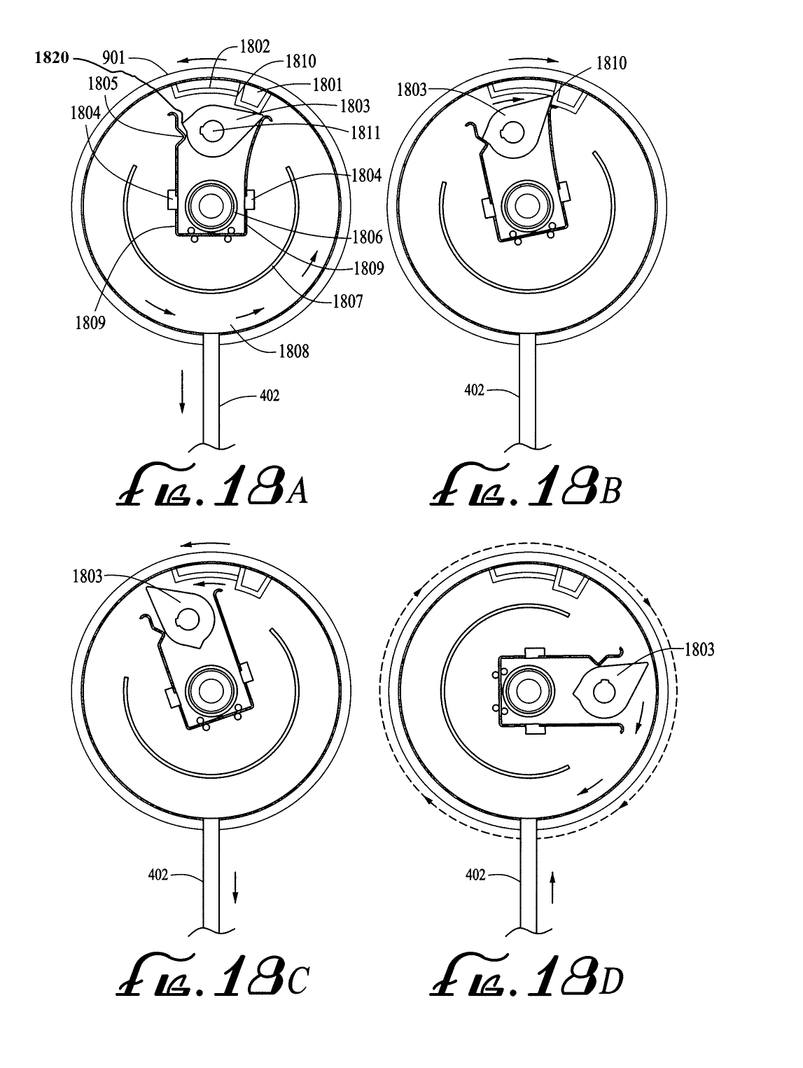

The cord 902 is attached at an attachment point 903 above lock 301. The earpiece 201 is then secured in the loop 401 as described with reference to FIG. 2. The embodiment for the inner retractable mechanism with “pull to stop” functionality is further described below in connection with FIG. 18. This embodiment may utilize any of the loop and lock embodiments described herein rather than limited exclusively to the type depicted in FIG. 7. This embodiment allows the user to attach the embodiment at a pocket or waist level and still be used with the earpiece while so attached.

FIG. 7B shows the earpiece 201 with loop 401 around its neck 202. FIG. 7C shows the loop 401 tightened around the neck as previously described with reference to other figures. FIG. 7D shows the embodiment with the decreasing cord 902 extended from internal coiling mechanism 905. In one embodiment, button actuator 904 causes the reel 905 to automatically rewind the cord.

In some embodiments, the clip type attachment device 711 may be replaced with the adhesive, magnets or for example hook and loop materials. Such an embodiment may be suitable for installation on an automobile headrest or seatbelt, for examples, so the user could rely on the earpiece being in a known location when a call is to be initiated or answered. In another embodiment, an elastic band is provided to reside on an automobile headrest and provide a seating location for clip attachment device 711 so that no damage or visual defect is caused by installation or removal of the device from the headrest.

FIG. 8A and FIG. 8B show another embodiment as the attached mechanism. Earring hook 1001 is attached to the extension 601 of loop 401 above the lock 301 at an attachment point 1002. The earpiece 201 can be transferred quickly to the ear from its non-use dangling position.

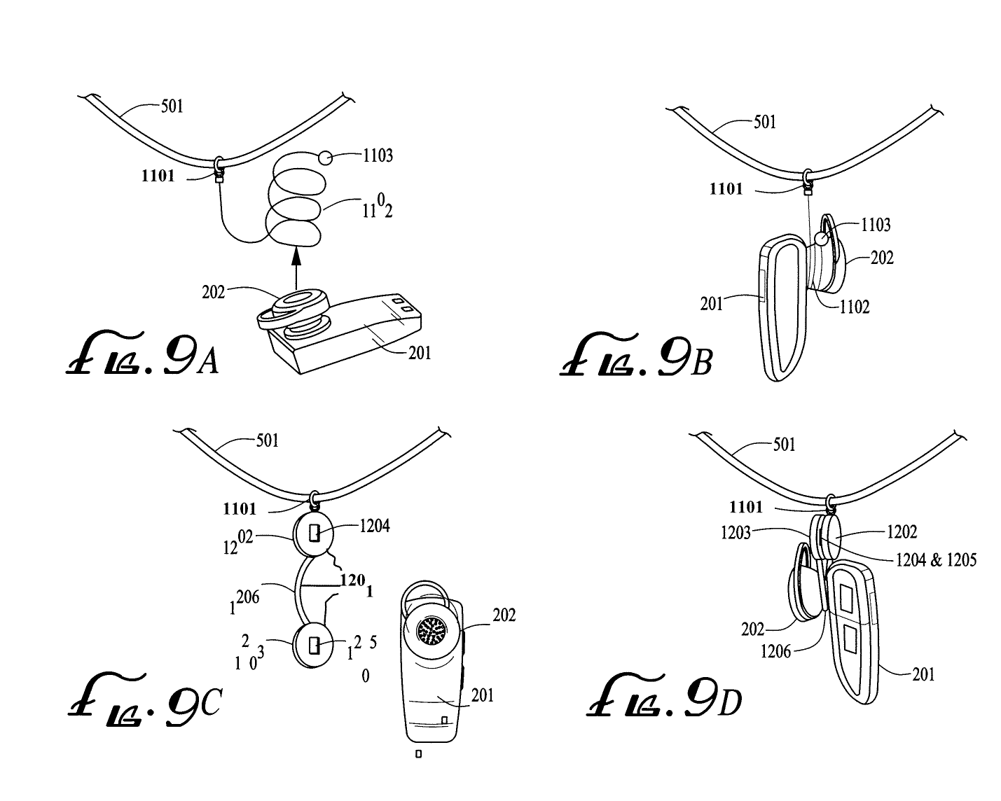

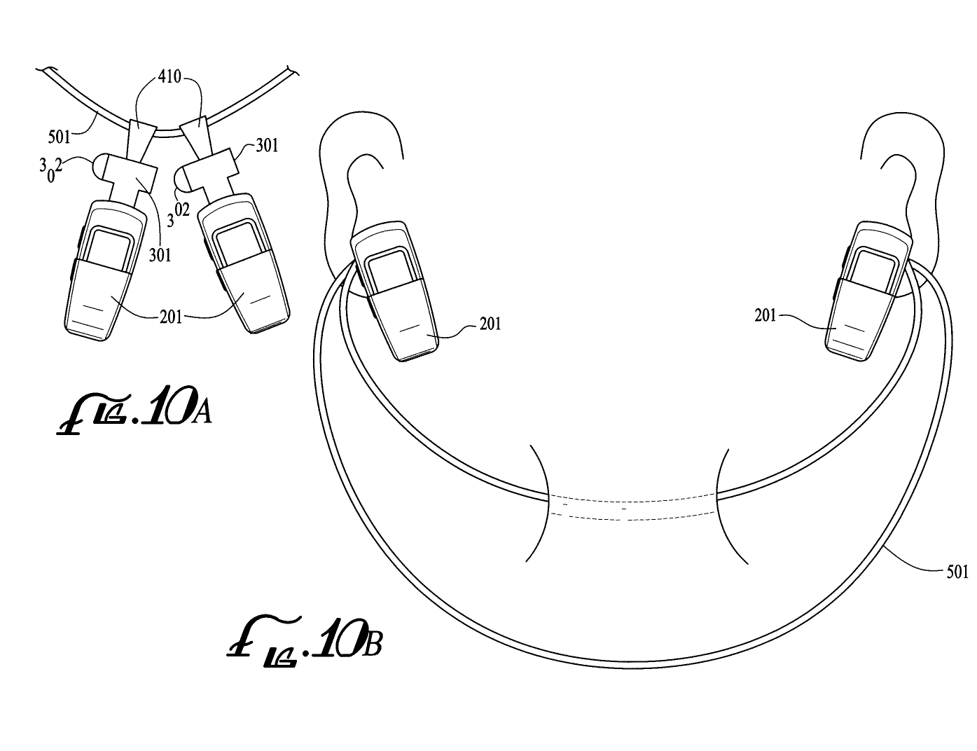

FIG. 9A and FIG. 9B show another embodiment unit that may be adapted into any of the herein-described embodiments. FIG. 9A shows a circular memory wire or other wire that will be wrapped around the neck 202 of the earpiece 201. The holding unit is attached to the attachment device 501 by the at the attachment clasp 1101, which may be an interchangeable, removable or permanent attachment. The coils 1102 are wrapped around the neck 202 of the earpiece 201. The user may hold the coil end 1103 to help to attach and detach the wireless unit 201.

FIG. 9B shows the earpiece 201 attached to the coil 1102 around the neck 202. To remove the earpiece 201 from the coils 1102, the user may grab onto the coil end 1103. This embodiment may be less ideal then the previously described embodiments because 1) the coil 1102 may not fit all types and sizes of wireless devices and 2) there is more dexterity required to grab the coil end. However, due to the small size, this embodiment may be preferred by some users.

FIG. 9C and FIG. 9D also show another embodiment of the holding unit. FIG. 9C shows a holding unit coupled to the attachment device 501 at the attachment clasp 101, which may be an interchangeable, removable or permanent attachment. The connecting device 1201 is fastened to a hooking/sticking/magnetic part 1202 attached to a band 1206 that is attached to the second part of the hooking/sticking/magnetic part 1203.

FIG. 9D shows the band 1206 is wrapped around the earpiece 202 of the wireless device 201. The two hooking/sticking/magnetic parts 1202 and 1203 are attached to each other via the hooking/sticking/magnetic mechanism 1204 and 1205. This embodiment shows a metal band 1204 that is attached to the hooking/sticking/magnetic part 1202 on the top and bottom of the metal band 1204. Then the hooking/sticking/magnetic parts 1204 and 1205 is inserted into the open part of the metal band 1204 to fasten the hooking/sticking/magnetic parts 1204 and 1205 so that the earpiece 202 is securely attached via the band 1206 around the earpiece 202. The hooking/sticking/magnetic part 1205 may also be comprised of other material, including but not limited to hook and loop apparatus including VELCRO, magnets or another type of hook mechanism known to skilled persons. For example, element 1204 may be material of a hook moiety and element 1205 may be material of a loop moiety. Alternatively, element 1204 may be a permanent magnet and element 1205 may be a ferromagnetic metal. These are merely two examples of the myriad possibilities. In one embodiment, band 1206 has high elasticity to increase the number of devices it can securely retain.

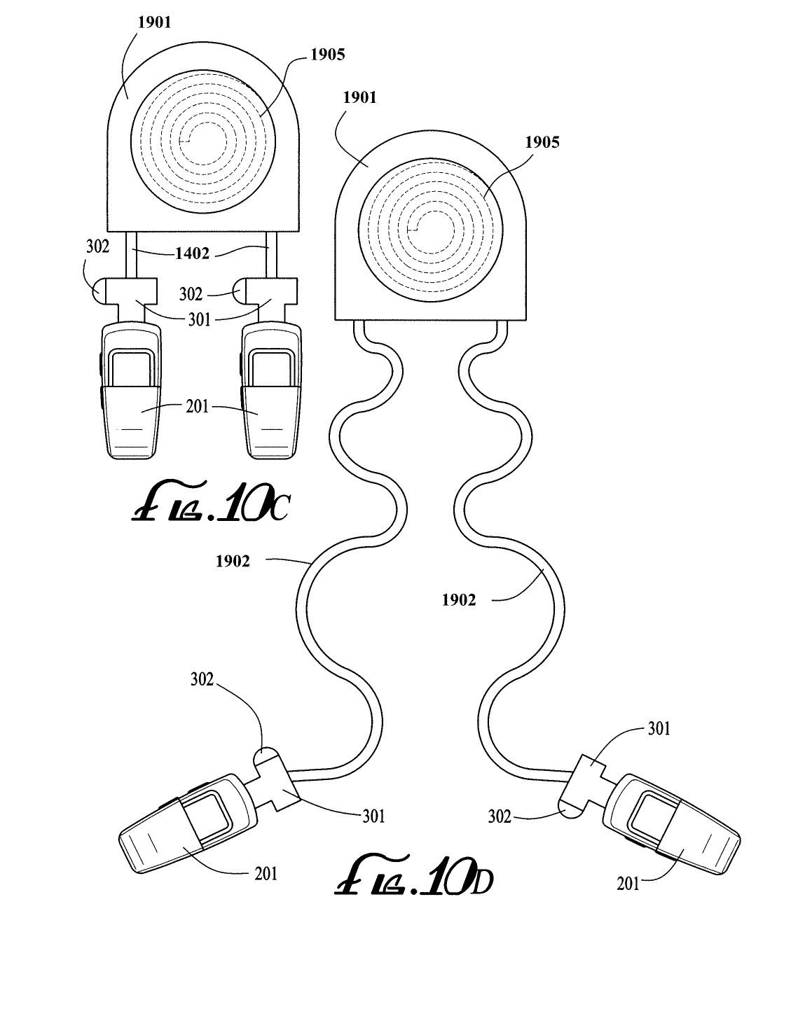

FIG. 10A shows a multiple headset/earpiece holder that allows the user to attach more than one earpiece in proximity to a user. FIG. 10B shows how the multiple earpieces may be used for stereo sound or the use of simultaneous communication devices in the ears of the user.

FIG. 10C shows the attachment device similar to FIG. 7A. The embodiment shown in FIG. 10C has a reel 1901 that separately attaches two telecommunication devices 201. FIG. 10C shows the recoiled position and FIG. 10D shows the uncoiled position that allows the user to extend the telecommunication devices 201 to the user's ears. Then when the cord 1902 for either devices 201 is tugged, reel 1905 recoils to return each of the telecommunication devices 201 to its original position such as shown in FIG. 10C. In an alternative embodiment, pulling on one cord causes the reel 1905 to only rewind the cord for that device.

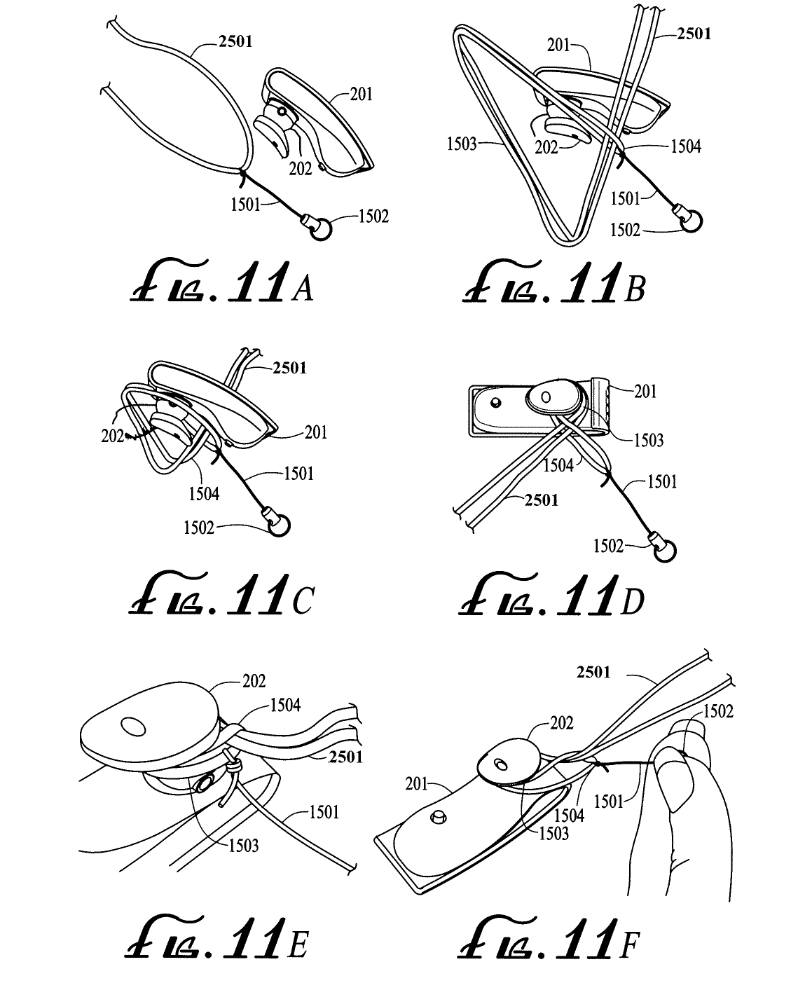

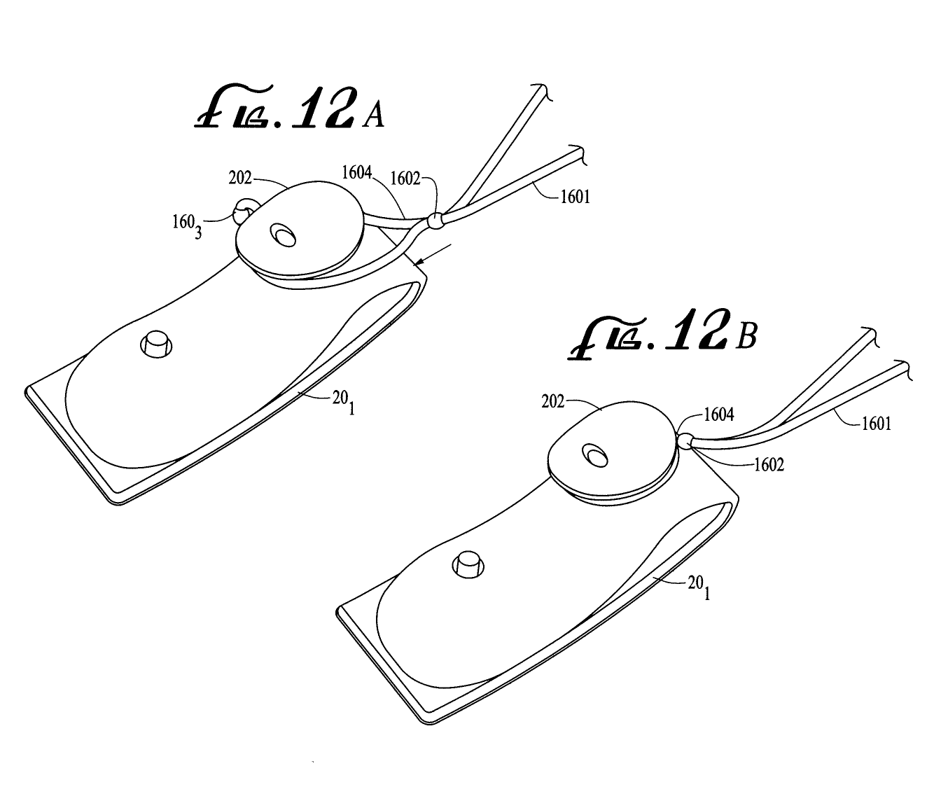

FIG. 11A shows an attachment device 2501 attached to an unlooping cord 1501. FIG. 11B shows the creation of the looping holding mechanism 1503 by inserting the attachment device 2501 in between the cords 1504 above the unlooping cord 1501. FIGS. 11C through 11E show the embodiment being secured to the neck 202. FIG. 11D shows another view of FIG. 11C. FIG. 11E shows another view of the looping holding mechanism of FIG. 11C. Unlike a lanyard, FIG. 11F shows how this securing mechanism 1504 may be easily removed by pulling on the unlooping cord 1501 by grasping and pulling on the cord end 1502.

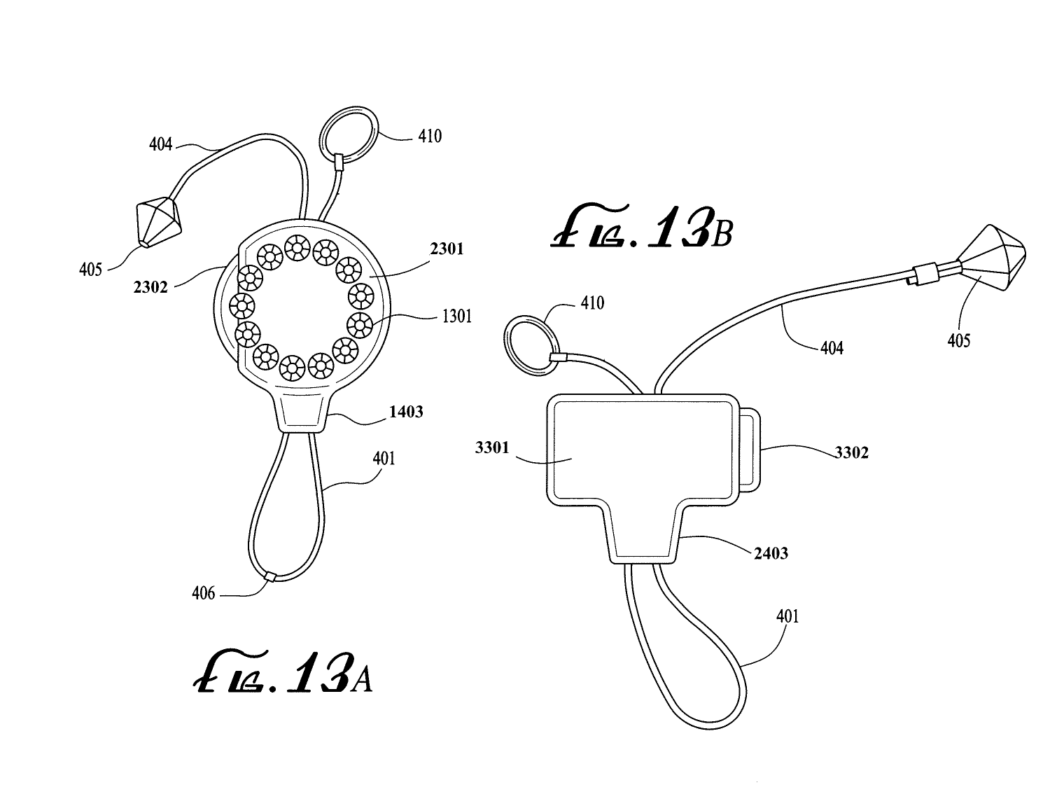

FIG. 12A shows another embodiment. The material of this cord 1601 allows a narrows in diameter when stretched. The lock of this embodiment is formed as a slider 1602 having a diameter that slides along the cord in a narrowed (stretched) disposition but frictionally engages the cord at rest to securely maintain its position when the cord returns to the rest or steady state position. The cord 1601 end forms a loop 1604. A stopper 1603 prevents the slider solid object 1602 from passing beyond the end of the loop 1604. The loop 1604 can be placed around the neck 202 of the earpiece 201. FIG. 12B shows the slider 1602 being secured around the neck 202 of the earpiece 201, thus reducing the size of the loop 1604. As noted above, the special nature of this cord is such that it must be stretched to decrease the diameter and allow the slider 1604 to move. Without decreasing the diameter of the cord 1601, the slider 1604 will not move without significant pressure.

FIG. 13A shows a view of an embodiment of the loop lock 301 decorated with crystals 1301. In this embodiment, the spacer 1403 is integrally formed with the body of lock 2301. Tension releasing mechanism 2302 releases tension to permit continuous size changes in the loop 401 subject to the limitation of the stop 406. In this embodiment, like that described with FIG. 6A and FIG. 6B above, the loop size is reduced by pulling on the loose end 405 of the cord 404. Connector 410 permits connection of the lock 2301 to an attachment device. In some embodiments, a small unlooping cord (not shown) may be provided to facilitate removal of, e.g. the earpiece from the loop 401 by making it easier to re-expand the loop 401. In on embodiment, the lock has a long cross dimension of 28 mm, a width of 20 mm and a thickness of five mm, the spacer 1403 is four mm in width and five mm in length.

FIG. 13B shows another embodiment style with the spacer 2403 incorporated into the body of the lock 3301. While this lock 3301 has a different shape, it functions as otherwise described in reference to FIG. 13A. Depression of tension release mechanism 3302 releases the cord 404 to permit changes in the size of loop 401 by, for example, pulling on cord end 405. In on embodiment, the lock has a long cross dimension of 19 mm, a width of 14 mm and a thickness of five mm, the spacer 1403 is four mm in width and five mm in length.

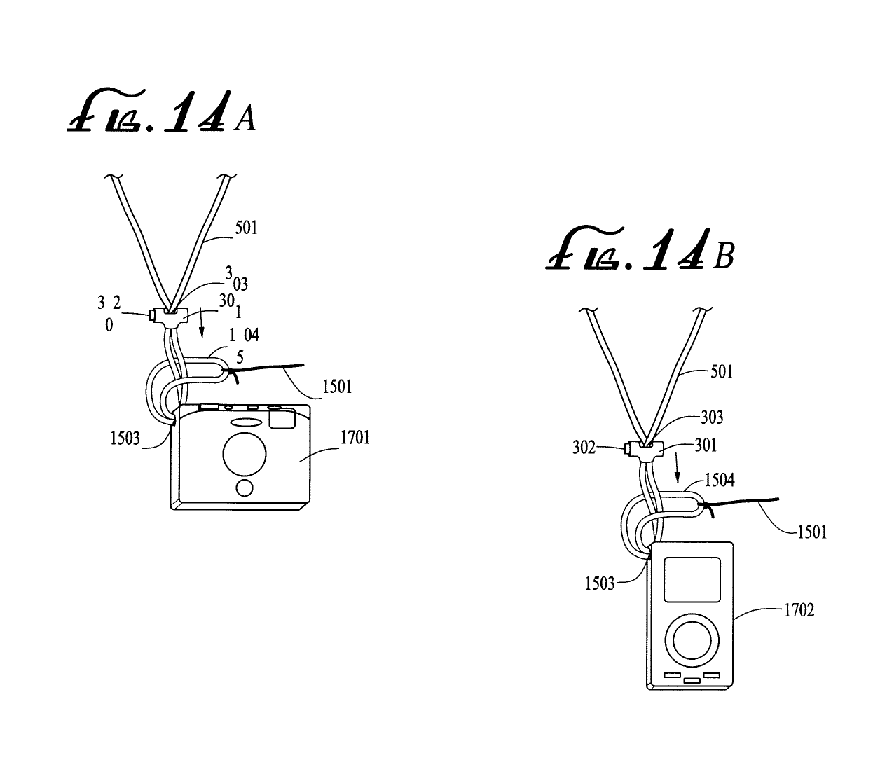

FIG. 14A shows a looping holding mechanism 1503 of one embodiment with an unlooping cord 1501 in conjunction with a secondary lock 301 having a tension release mechanism 302 and attached to an electronic recording device 1701 here shown as a camera. FIG. 14B shows the combination looping holding mechanism 1503 in one embodiment with an unlooping cord 1501 and a holding mechanism 301 having a tension release mechanism 302 that can be utilized for another type of electronic sound device 1702.

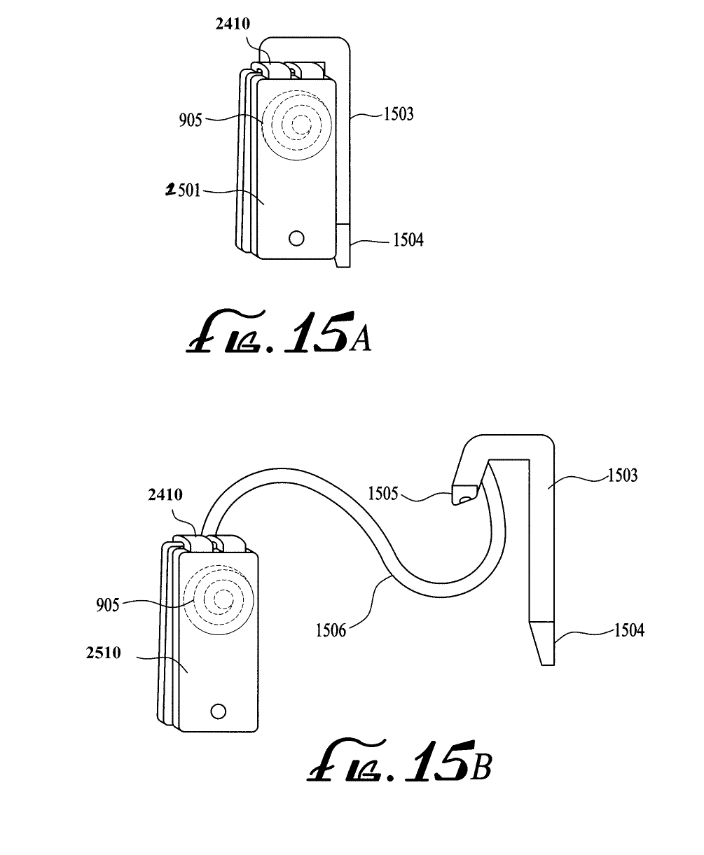

FIG. 15A shows another embodiment with the telecommunication device 2501 having an internal retractable cord for attachment to a wired or wireless earpiece device 1503 that utilizes the retractable mechanism 905. In the wired case the reel 905 takes up the slack in the cord avoiding the loose dangling cords that may hamper user action. In the wireless case, the reel 905, lock, and loop are integrated with the transmission/receiving base station so that the base station location and its integrated attachment mechanism 2410 ensures proximity to the user.

FIG. 15B is another view of the embodiment shown in FIG. 15A illustrating an internal retractable cord 1506. The cord 1506 dispenses from the base station 2501. The unit 2501 may be attached to the user's body, clothes or accessories and reach the user's ear while secured. An internal retractable cord within the telecommunication device such as a BLUETOOTH receiving device. The retractable cord is dispensed so that the wireless device such as an earpiece with a microphone is secured adjacent to a user's ear and remains connected to the telecommunication device by the cord. The cord is retracted by a tug on the cord or by pushing a button (not shown) on the telecommunications device. This eliminates unused dangling wires.

FIG. 16A shows a similar embodiment to FIG. 15 but coupled to attachment device reel housing 3501 retains two reels 905 to permit. A second earpiece 1601 to be utilized to convey stereo sound. Again the earpieces may be wired or wireless, and reels 905 may be individually actuated to take up the wire or attachment cord as appropriate. Earpiece 1503 includes a speaker 1505 to emit sound to a users ear and a microphone 1504 to convey the users voice to the base unit 3501.

FIG. 16B shows another view of the embodiment from FIG. 16A and the sound conveying mechanisms 1505 and 1601 dispensed from the holding unit 1501 such as a BLUETOOTH receiving device and allow stereo sound. Each of the retractable cords is separately dispensed so that a wireless device such as an earpiece or an earpiece with a microphone is respectively secured adjacent to each ear of a user while each wireless device remains connected to the telecommunication device by its respective cord. Each cord is retracted by a tug on the respective cord or by pushing a button on the telecommunication device.

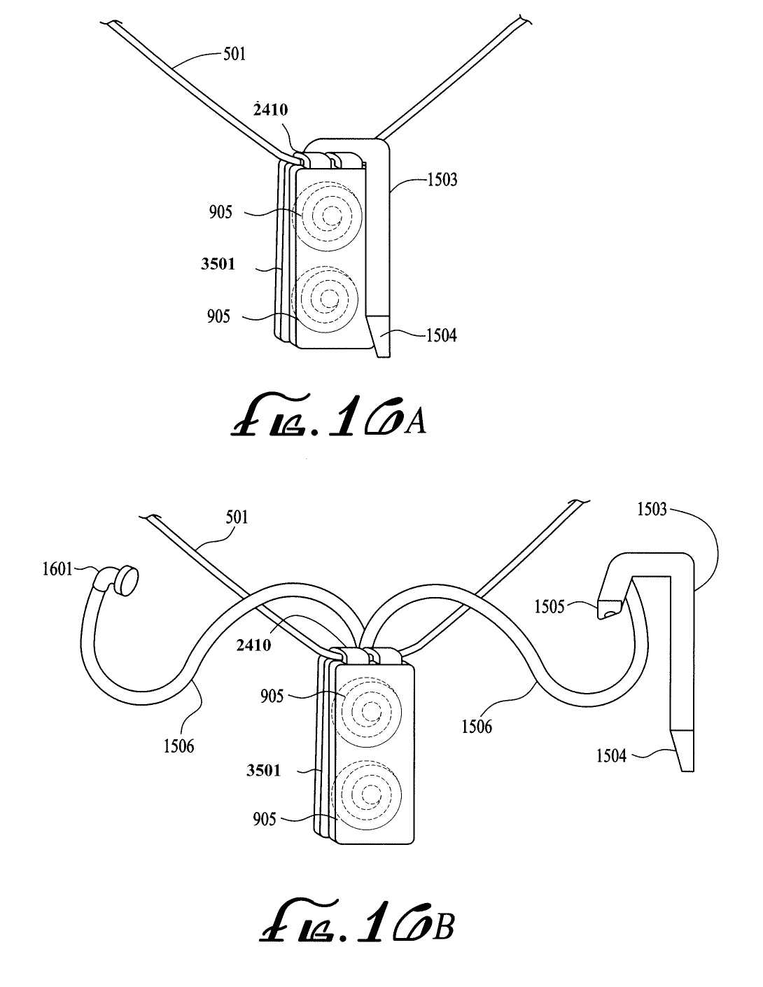

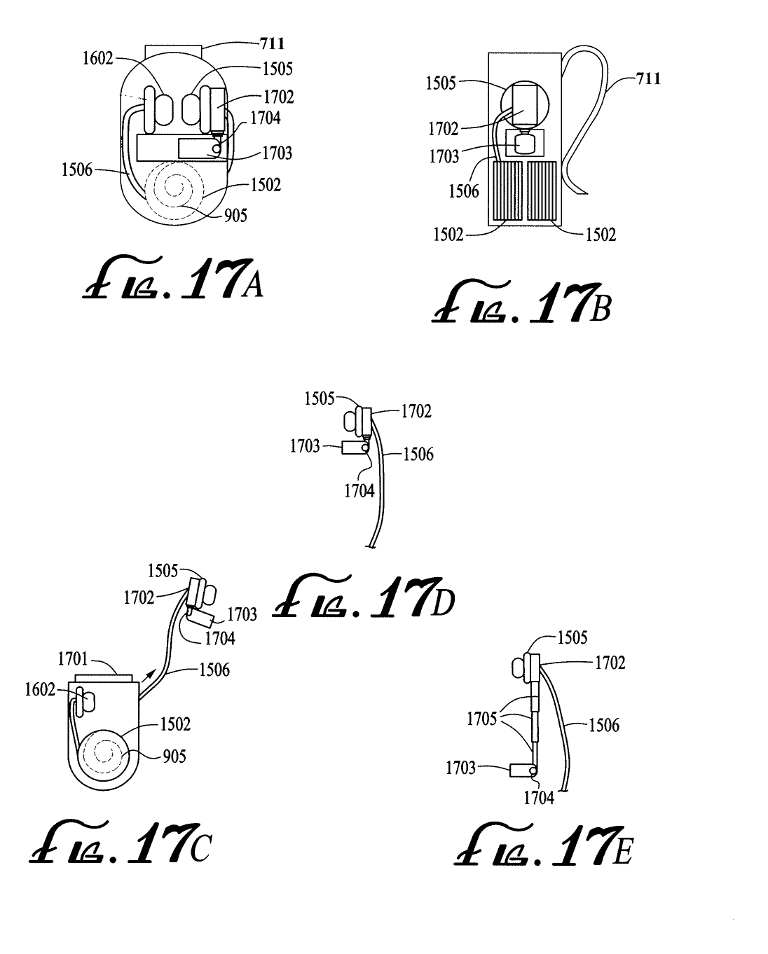

FIG. 17A shows another embodiment with a clip attaching mechanism 701. This embodiment contains two sound conveying mechanisms 1505 and 1602 with reel 905.

FIG. 17B shows another view of the embodiment from FIG. 17A from the side view.

FIG. 17C shows another view of the embodiment from FIG. 17A that shows the earpiece cord 1506 in a dispensed position.

FIG. 17D shows another view of the embodiment from FIG. 17A. This embodiment additionally shows an extendable sound receiving device or speaker 1702 and a swivel joint 1704 for the sound recording device or microphone 1703. FIG. 17E shows another view of the embodiment from FIG. 17A and shows the extendible sound recording device 1704 in an extended position 1705. Microphone 1703 telescopes out from speaker 1702. Swivel joint 1704 provides at least one and typically two degrees of freedom in orienting the microphone 1703.

FIG. 18A shows an embodiment for the retractable cord rewinder with a pull to stop functionality. This figure shows the position of the stopper when the cord/wire is being dispensed. This functionality is based on a pull reel with a wound flat metal spring coiled around a stationary center holding piece (not shown). When the internal cord 402 is pulled away from the reel mechanism 901, the inner rotating reel 1808 moves counter clock wise and the tear-shaped stopper 1803 rotates on its axis 1811 and passes around the internal large stopper 1801 and smaller stopper 1802. This movement will continue without interruption until the dispensation of the internal cord 402 ceases or the end of the cord 402 is reached.

FIG. 18B shows another view of the embodiment from FIG. 18A shows the stopping position of the tear-drop shaped stopper 1803 when the dispensation tension on the internal cord 402 ceases. The stopping position 1810 rests between the large stopper 1801 and smaller stopper 1802. The stopper 1804 bottom groove catches on the metal band groove 1805 to prevent further movement. This holds the cord at its extended position.

FIG. 18C shows another view of the embodiment from FIG. 18A when a slight pull on the internal cord 402 causes the tear-shaped stopper 1820 to rotate on its axis 1811 and change direction.

FIG. 18D shows another view of the embodiment from FIG. 18A where the tear-shaped stopper 1803 is released from the position in FIG. 18C such that the inner rotating reel 1808 will continue to recoil until the internal cord 402 reaches its end or is dispensed again.

Various features of several embodiments are described herein, in some cases with reference to only one embodiment, it is intended that these features may be used or incorporated in other embodiments without departing from the spirit or scope of the invention.

One embodiment of the invention provides a holding unit for a wireless hands-free device to exchange transmissions with a telecommunication device. The telecommunication device can transmit signals to the wireless device and signals from the wireless device in any suitable frequency band. The wireless device may include a microphone and/or a speaker. While attached to the holding unit, the wireless device in use is hung on a user's ear to perform wireless exchange of signals with the telecommunication device. The holding unit is carried on the user's body, clothing, accessory, or otherwise proximate to the user such that the wireless device is easily accessed and used while securely fastened to prevent loss of the wireless device.

The telecommunication device can be a mobile phone, computer, laptop, MP3 player or similar electronic device. The wireless telecommunication device may be a BLUETOOTH headset or similar device. An electronics device may be a camera, video recording unit, I-POD, music player, or similar device that stores, captures, or otherwise transmits data.

The lock, various clasps and automatic cord rewinding mechanism and other described components of the embodiments may be made from, but are not limited to, ABS plastic or other similar plastic, sterling silver or other metal. The loop, attachment device and flexible member may be made from, but are not limited to, metal, silk, leather, synthetic leather, silver, other precious metal, or stretchy jewelry cord or stainless steel wire. The earring may be manufactured from many materials including but not limited to metal or precious metal.

The wire clasp holding unit 1102 may be made from a wire or plastic material that holds a shape or can be molded to a shape. The hooking/sticking holding units may be made from plastic, leather or a fabric material. The hooking/sticking holding unit may be a metal hook, magnetic material, hook and loop apparatus including VELCRO or other fastening methods. The hooking/sticking holding unit may be made from a stretchy or elastic material. The hooking units or holding mechanisms may be embellished by adding decorative items and adding color, crystals, beads or interchangeable face plates.

Once the wireless unit is attached to the holding unit and placed around the user's neck or attached to the user's body, the unit is easily accessible so that the user accesses the unit and moves the unit to his or her ear with one hand. For example, when the telecommunications device rings, the user answers the call by moving the wireless device from his or her chest to ear and pressing the answer button on the wireless unit. At the end of each call, the user simply flicks the unit out of his or her ear; the unit is continuously secured and attached to the body of the user.

Because the unit is proximately maintained within the reach of either hand, the user need not search for either the wireless or telecommunications devices or remove or replace the wireless unit from or into a carrying device before, between or during use. When driving, the time to find such a device and use a device may be reduced by 50% or more, which are precious seconds when behind the wheel of a car. Optimal driving position may be maintained. Similarly, when finished using the wireless device, it is easily removed from the ear in less than 50% of the time it would take to move the unit to a purse, pocket or other location.

Due to the long battery life of such wireless units, the wireless unit may remain in the holding unit for one or more days without the need to recharge. When removing the unit from the holding unit to recharge the unit, the user may, for example, apply pressure to the end of the tension release mechanism 302, and the device may be easily unsecured from the holding unit.

The invention has been described using exemplary embodiments. However, it is to be understood that the scope of the invention is not limited to the disclosed embodiments. On the contrary, it is intended to cover various modifications and similar arrangements and equivalents. The scope of the claims, therefore, should be accorded the broadest interpretation so as to encompass all such modifications, similar arrangements and equivalents.

What is claimed is:

1. An apparatus comprising:
a loop having a size continually adjustable within a range the loop to receive a wireless earpiece;
a lock coupled to the loop to maintain the loop at a selected size within the range to securely retain the wireless earpiece; and
an attachment mechanism coupled to the lock to retain the loop in proximity to the user both while the retained earpiece is in a use position and while the retained earpiece is in a non-use position.

2. The apparatus of claim 1 further comprising:
a spacer to maintain a minimum separation between the loop and the lock.

3. The apparatus of claim 2 wherein the spacer is formed as an integral extension of the lock.

4. The apparatus of claim 1 wherein the attachment mechanism comprises one of:
a clip, a necklace, a cord, a hook, a band, a bracelet, a clasp or pin.

5. The apparatus of claim 1 further comprising:
a stopper disposed along the loop to limit movement of the loop through the lock.

6. The apparatus of claim 1 further comprising:
a cord coupled between the loop and the attachment mechanism; and
a reel coupled to the attachment mechanism to dispense and rewind the cord responsive to a user action.

7. The apparatus of claim 6 wherein the reel comprises one of a pull stop actuator or a button actuator.

8. The apparatus of claim 1 further comprising an unlooping cord coupled to the loop.

9. An apparatus comprising:
a wireless earpiece;
a loop having a size continually adjustable within a range the loop to receive a wireless earpiece; and
an attachment mechanism coupled to the loop to retain the loop in proximity to the user both while the retained earpiece is in a use position and while the retained earpiece is in a non-use position.

10. The apparatus of claim 9 further comprising:
a cord coupled between the loop and the attachment mechanism; and
a reel coupled to the attachment mechanism to dispense and rewind the cord responsive to a user action.

11. The apparatus of claim 10 wherein the reel comprises one of a pull stop actuator or a button actuator.

12. The apparatus of claim 9 further comprising an unlooping cord coupled to the loop.

13. An apparatus for securing a wireless device adjacent to the torso of a user, the apparatus comprising:
a base unit having a cord retracting mechanism within the base unit; and
a cord having a first end and a second end, the first end in communication with the cord retracting mechanism, the second end of the cord to removably couple to a wireless earpiece such that the cord retracting mechanism dispenses a length of the cord when the user places the earpiece adjacent to a user's ear and the cord retracting mechanism retracts the length of the cord when the user removes the mobile wireless telecommunication device from adjacent to the user's ear and the earpiece remains attached to the cord at all times.

14. The apparatus of claim 13 wherein the cord retracting mechanism comprises a retractable cord rewinder having a pull to stop functionality.

15. The apparatus of claim 14 wherein the retractable cord rewinder includes a rotatable substantially tear shaped stopper.

16. The apparatus of claim 13 further comprising:
an earpiece having an extendable microphone or sound recording device.

17. A method comprising:
securely ensnaring a protrusion of a wireless earpiece within a loop having a size that is continuously adjustable within a range;
attaching the loop and ensnared earpiece to be proximate to a user, in a non-use position;
placing the earpiece in a use position while the earpiece remains ensnared;
removing the earpiece from the use position; and
automatically returning the earpiece to the non-use position proximate to the user.

18. The method of claim 17 further comprising the steps of:
dispensing the cord from a cord retracting mechanism coupled to the loop; and
retracting the cord into the cord retracting mechanism after removing the electronic communication device from the use position.

19. An apparatus comprising:
a speaker to reside adjacent to a users ear during use; and
an telescoping microphone coupled to the speaker.

20. The apparatus of claim 19 further comprising:
a swivel joint coupled to the telescoping microphone to permit the microphone to rotate in at least one degree of freedom relative to a direction of telescoping.

21. The apparatus of claim 19 further comprising:
a cord coupled to the speaker; and
a reel having pull stop actuation coupled to the cord to dispense or retract the cord responsive to user action.
